(19) United States
(12) Patent Application Publication
(10) Pub. No.: US 2013/0236226 A1
(43) Pub. Date: Sep. 12, 2013

(54) IMAGE FORMING APPARATUS WITH COMPACT SHEET CONVEYANCE PATH

(71) Applicant: Yusuke FUNAYAMA, Kanagawa (JP)

(72) Inventor: Yusuke FUNAYAMA, Kanagawa (JP)

(21) Appl. No.: 13/751,258

(22) Filed: Jan. 28, 2013

(30) Foreign Application Priority Data
Mar. 9, 2012 (JP) 2012-053095

(51) Int. Cl. G03G 15/00

(52) U.S. Cl. CPC G03G 15/6579
USPC 399/364

(57) ABSTRACT

An image forming apparatus comprises an image formation unit to form an image on a sheet, a reversing path extended vertically to receive and reverse front and rear sides of the sheet by changing a conveyance direction of the sheet to an opposite direction, a curved importing path to send the sheet with the image into the reversing path, an exporting path to receive the sheet sent from the reversing path, a sheet re-feeding path to re-feed the sheet from the exporting path to the image formation unit, and a base structure to support a main body of the image forming apparatus at a bottom thereof. The base structure includes a guiding surface to guide the sheet sent from the importing path to the reversing path and change a sheet conveyance direction substantially from a vertical direction to a horizontal direction.

### CROSS-REFERENCE TO RELATED APPLICATION

This patent application is based on and claims priority pursuant to 35 U.S.C. §119 to Japanese Patent Application No. 2012-053095, filed on Mar. 9, 2012 in the Japanese Patent Office, the entire disclosure of which is hereby incorporated by reference herein.

### BACKGROUND

1. Field

The present invention relates to an image forming apparatus, such as a copier, a printer, a facsimile, etc.

2. Related Art

Conventionally, as described in Japanese Patent No. JP-3816678-B2 (JP-2000-077858-A), in an image forming apparatus employing a photoconductor as an image bearer, a latent image is formed on the photoconductor when the photoconductor is charged by a charger and is exposed by an optical device or the like. The latent image is subsequently developed by developer stored in a developing device into a visible toner image. Subsequently, the thus-formed toner image is transferred onto a sheet like recording medium by a transfer device and is fixed on the medium by a fixing device, thereby generating a final image.

A main body of the image forming apparatus includes front and rear side plates, for example, made of steel, a structure forming a frame of the apparatus main body, and an exterior cover covering the structure. The structure is assembled by linking the above-described front and rear side plates and a base structure as a bottom with frame parts and/or a stay. The photoconductor, charger, optical writing device, transfer device, fixing device, and a sheet feeder are housed in the structure.

Further, an image forming apparatus capable of forming images on both sides of a sheet respectively by reversing front and back sides thereof using a switchback system is known. For example, a sheet conveyor is installed in a structure as a sheet reversing device that reverses front and back sides of a sheet using a switchback system.

FIG. 12 is a schematic diagram illustrating an image forming apparatus with a conventional sheet reversing system. As shown therein, the conventional sheet reversing system includes a reversing path to change a conveyance direction of a sheet, a sheet importing path feeding the sheet into the sheet reversing path after completing a fixing process, a curved discharge path to which the sheet is fed out from the sheet reversing path, and a sheet re-feeding path to re-feed the sheet lying on the discharge path to an image formation unit provided within the body of the apparatus.

A sheet with a toner image formed by the image formation unit on its one side and fixed after that is then horizontally conveyed toward the reversing path via a curved sheet importing path. When a trailing end of the sheet is sent to the reversing path, a pair of transfer rollers installed in the reversing path is rotated clockwise as shown in the drawing to send out the sheet from its trailing end serving as a leading end thereof, at that time, from the reversing path to the discharge path. The sheet sent out in this way is conveyed to the re-feeding path from the discharge path and is fed again into the image formation unit, so that a second toner image is additionally formed on the other side of the sheet.

In the conventional sheet reversing system of FIG. 12, however, a conveyance direction of a sheet horizontally conveyed after completing the fixing process is changed to an opposite direction by the angle of 180 degrees by the sheet importing path and is further fed into the reversing path extending horizontally. Therefore, when a rigid sheet, such as a cardboard, etc., is used and subjected to such a sheet reversing process, it tends to get jammed in the sharply curved importing path thereby causing defective sheet conveyance.

Conceivably, the foregoing problem can be solved by defining the sheet reversing path vertically rather than horizontally as different from the sheet reversing device of FIG. 12. Specifically, in such a sheet reversing device provided in the image forming apparatus, a conveyance direction of a sheet horizontally conveyed after completing the fixing process is changed by 90 degrees by a sheet importing path and is further fed into a reversing path extending vertically. With this, since the sheet importing path is more gradually curved than a path in which the sheet conveyance direction is changed by the angle of 180 degrees, the sheet rarely jams in the sheet importing path even the rigid sheet is used, thereby capable of reducing defective sheet conveyance.

However, since the reversing path 204 at least requires a size corresponding to a length of the sheet in a sheet conveyance direction, the height and therefore also the bulk of a straight vertical reversing path simply increases the height and therefore also the bulk of the image forming apparatus.

### SUMMARY

Accordingly, the present invention provides a novel image forming apparatus that comprises an image formation unit to form an image on a sheet, a reversing path extended vertically to receive and reverse front and rear sides of the sheet by changing a conveyance direction of the sheet to an opposite direction, a curved importing path to send the sheet with the image formed by the image formation unit into the reversing path, an exporting path to receive the sheet sent from the reversing path, a sheet re-feeding path to re-feed the sheet on the exporting path to the image formation unit, and a base structure to support a main body of the image forming apparatus at a bottom thereof. Such a base structure includes a guiding surface to guide and change a conveyance direction of a tip of the sheet sent from the importing path to the reversing path substantially from a vertical direction to a horizontal direction.

In another aspect of the present invention, the base structure includes a recessed portion having a bottom face on its upper surface and the bottom face constitutes the guiding surface.

In yet another aspect of the present invention, the base structure is made of metal and the recessed portion is prepared by applying a deep drawing process to the base structure.

In yet another aspect of the present invention, the reversing path includes a plate as a reversing path forming member, and the plate and the recessed portion are relatively positioned to provide a smooth joint therebetween.

In yet another aspect of the present invention, the reversing path forming member overlaps with the recessed portion up to a position at which a virtual line extending through the end of the reversing path forming member and the bottom face of the recessed portion intersect each other.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a diagram illustrating a base structure having an aperture and a sheet feeding surface according to one embodiment of the present invention;

FIG. 2 is a schematic block diagram illustrating one example of a printer according to one embodiment of the present invention;

FIG. 3 is a perspective view illustrating a first exemplary configuration of the base structure according to one embodiment of the present invention;

FIG. 4 is a diagram illustrating a width of a guiding surface in a recessed portion according to one embodiment of the present invention;

FIG. 5 is a diagram illustrating a depth of the recessed portion;

FIG. 6 is a diagram illustrating an aspect in which a guide plate forming a switchback path is disposed overlapping the recessed portion according to one embodiment of the present invention;

FIG. 7 is a diagram illustrating a base structure with a box having a flat upper surface according to one embodiment of the present invention;

FIG. 8 is a diagram illustrating a recessed portion provided to increase rigidity of the base structure according to one embodiment of the present invention;

FIG. 9 is a diagram illustrating a base structure with its upper surface being partially used as a guiding surface while omitting the recessed portion therefrom according to another embodiment of the present invention;

FIG. 10 is an exploded perspective view illustrating a second exemplary configuration of the base structure according to another embodiment of the present invention;

FIG. 11 is a schematic cross-sectional view illustrating a box-shaped base structure assembled by combining an upper metal plate and a lower metal plate according to another embodiment of the present invention; and

FIG. 12 is a diagram schematically illustrating a conventional sheet reversing device.

### DETAILED DESCRIPTION OF THE INVENTION

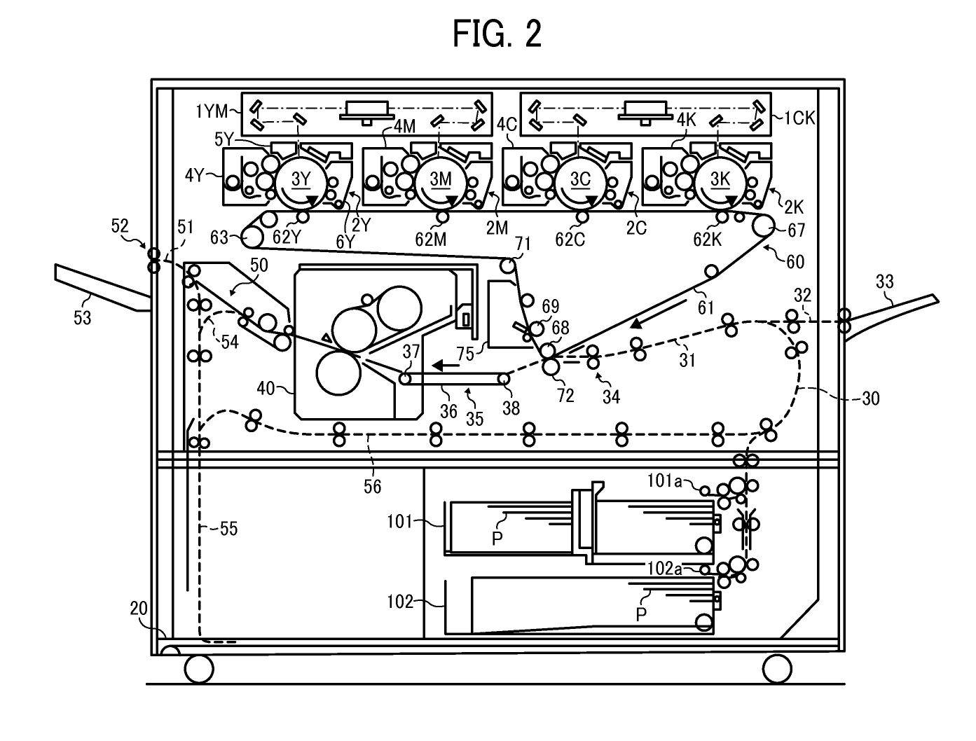

Referring now to the drawings, wherein like reference numerals designate identical or corresponding parts throughout the several views thereof and in particular to FIG. 2, one embodiment of the present invention applied to a printer as an image forming apparatus to form an image using an electro-photographic technology is described.

As shown there with a schematic block diagram, one example of the printer of this embodiment includes two optical writing units 1YM and 1CK and four process units 2Y, 2M, 2K, and 2C to form toner images of cyan (C), magenta (M), yellow (Y), and black (K) colors. The printer also includes a sheet feeding path 30, a pre-transfer conveyance path 31, a manual sheet feeding path 32, a manual sheet feeding tray 33, a pair of registration rollers 34, a conveyance belt unit 35, an fixing device 40, a conveyance direction switching device 50, a sheet exiting path 51, a pair of sheet exiting rollers 52, a sheet exiting tray 53, a first sheet feeding cassette 101, a second sheet feeding cassette 102, a re-feeding device, and a base structure supporting the apparatus at a lower section.

These first sheet feeding cassette 101 and second sheet cassette 102 each accommodates a bunch of sheets P as recording media. Further, a topmost sheet P on the bunch of sheets is sent toward the sheet feeding path 30 by rotating and driving the sheet feeding roller 101a or 102a. This sheet feeding path 30 is connected to the pre-transfer conveyance path 31 that conveys the sheet P just before the second transfer nip described later in detail. The sheets P sent out from the sheet feeding cassettes 101 and 102 enter the pre-transfer conveyance path 31 through the sheet feeding path 30.

The manual sheet feeding tray 33 is provided on a side of a printer housing and is openably closable. A bunch of sheets are manually set onto a top of the manual sheet feeding tray when the housing is open. The topmost sheet on the bunch of sheets P manually set is then sent out toward the pre-transfer conveyance path 31 by a feeding out roller provided for the manual sheet feeding tray 33.

Two optical writing units 1YM and 1CK each include a laser diode, a polygon mirror, and various lenses. The laser diode is driven based on image information read by an external scanner of a printer or image information coming from a personal computer. These optical writing units 1YM and 1CK provide optical scanning to photoconductors 3Y, 3M, 3C, and 3K as latent image bearers installed in the process units 2Y, 2M, 2C, and 2K, respectively. Specifically, the photoconductors 3Y, 3M, 3C, and 3K of the process units 2Y, 2M, 2C, and 2K are driven and rotated by a driving device, not shown, counterclockwise in the drawing. The optical writing unit 1YM provides such optical scanning processing by irradiating each laser beam to the photoconductors 3M and 3Y on driving while deflecting the laser beam along these rotational axes. Hence, electrostatic latent images are formed on the photoconductors 3M and 3Y based on M and Y image information pieces, respectively. The optical writing unit 1CK similarly provides such optical scanning processing by irradiating each laser beam to the photoconductors 3C and 3K on driving while deflecting the laser beam along these rotational axes. Hence, electrostatic latent images are formed on the photoconductors 3C and 3K based on C and K image information pieces, respectively.

These photoconductors 3Y, 3M, 3C, and 3K as latent image bearers in the process units 2Y, 2M, 2C and 2K each has a drum-shape. Further, the process units 2Y, 2M, 2C, and 2K each supports various devices disposed around the photoconductor 3Y, 3M, 3C, and 3K with a common supporter of a single detachable unit regarding the printer body. Each process unit 2Y, 2M, 2C or 2K has a similar configuration except for a toner color used in the unit.

Now, the process unit 2Y for Y color is typically explained with reference an applicable drawing. The process unit 2Y has a developing device 4Y for developing an electrostatic latent image formed on a surface of the photoconductor 3Y to a Y-toner image. The process unit 2Y further includes a charger 5Y that uniformly provides charge to a surface of the photoconductor 3Y being driven and rotated, and a drum cleaner 6Y to clean the surface of the photoconductor 3Y passing through a primary transfer nip for Y color by removing residual toner adhering to the surface thereof after a transfer process.

The printer shown in the drawing is a so-called tandem type, in which four process units 2Y, 2M, 2C, and 2K lines up in an endless movement direction of an intermediate transfer belt 61 described later in more detail.

The photoconductor 3Y has a drum-shape and is constituted by an original pipe made of aluminum and a photosensitive layer coated with organic photosensitive material having photosensitivity. However, the photoconductor 3Y can be an endless belt.

The developing device 4Y develops a latent image with two-component developer (hereinafter simply referred to as developer) containing non-magnetic Y toner and magnetic carrier, not shown. The developing device 4Y can be a type that executes development using one component developer instead of the two-component developer while excluding the magnetic carrier. A Y-toner supplying device, not shown, supplies Y toner stored in a Y toner bottle, not shown, to the developing device 4Y at an appropriate time.

As a drum cleaner 6Y, a fur brush that engages the photoconductor 3Y as a freely rotatable cleaning member is employed in order to enhance cleaning performance. This fur brush also functions to scrape off lubricant from solid lubricant, not shown, making the lubricant into a powder state and apply the lubricant power to a surface of the photoconductor 3Y. Otherwise, a cleaning blade as a cleaning member made of polyurethane rubber may be pressed against the photoconductor 3Y as an alternative.

A charge removing lamp, not shown, is provided above the photoconductor 3Y as a component of the process unit 2Y. The charge removing lamp removes charge remaining on a surface of the photoconductor 3Y passing through the drum cleaner 6Y by irradiating light thereto. The surface of the photoconductor 3Y losing the charge in this way is then uniformly charged by the charger 5Y and is subjected to optical scanning of the optical writing unit 1YM as described earlier. Here, the charger 5Y is driven and rotated receiving a charging bias from a power supply, not shown. However, a scorotron charger system may be employed instead of the above-described system to serve as a non-contact charger charging the photoconductor 3Y.

Although the process unit 2Y for Y color is typically described heretofore, the process units 2M, 2C, and 2K for M, C, and K colors have the similar configuration to that of the process unit 2Y as well.

Below the four process units 2Y, 2M, 2C, and 2K, a transfer unit 60 is disposed. In the transfer unit 60, an endless intermediate transfer belt 61 is provided and is stretched by more than one supporting roller, and is driven and rotated (i.e., endless movement) clockwise in the drawing by driving rotation of one of the supporting rollers while contacting the photoconductors 3Y, 3M, and 3K, and 3C. Hence, multiple primary transfer nips for Y, M, C and K colors are formed between these photoconductors 3Y, 3M, 3C, and 3K and the intermediate transfer belt 61, respectively.

In the vicinity of the primary transfer nips of Y, M, C, and K colors, the primary transfer rollers 62Y, 62M, 62C, and 62K are arranged as primary transfer members in a space surrounded by an inner circumference of the intermediate transfer belt 61, namely, within a belt loop, to press the intermediate transfer belt 61 against the photoconductors 3Y, 3M, 3C, and 3K, respectively. A primary transfer bias is applied to each of these primary transfer rollers 62Y, 62M, 62C, and 62K from a power source, not shown. Hence, a primary transfer electric field is formed in each of these primary transfer nips for Y, M, C, and K colors to electrostatically move a toner image on each of the photoconductors 3Y, 3C, 3M, and 3K toward the intermediate transfer belt 61.

Onto the outer circumferential surface of the intermediate transfer belt 61 that sequentially passes the primary transfer nips for Y, M, C, and K colors during its endless movement in the clockwise direction, each of the toner images is transferred and superimposed in succession in each of the primary transfer nips during the primary transfer process. With such superposition in the primary transfer process, a four-color toner image (hereinafter referred to as a four-color toner image) is formed on the outer circumferential surface of the intermediate transfer belt 61.

Below the intermediate transfer belt 61 as shown in the drawing, a secondary transfer roller 72 is disposed as a secondary transfer member. The secondary transfer roller 72 engages the intermediate transfer belt 61 at a portion opposed to the secondary transfer backup roller 68 from the outer circumferential surface of the intermediate transfer belt thereby forming a secondary transfer nip therebetween. Specifically, the secondary transfer nip is formed on the surface of the intermediate transfer belt 61 engaging the secondary transfer roller 72.

Further, a secondary transfer bias is applied to the secondary transfer roller 72 by a power supply, not shown. Whereas, the secondary transfer backup roller 68 disposed inside the belt loop is grounded. Hence, a secondary transfer electric field is formed in the secondary transfer nip.

Further, on the right side of the secondary transfer nip in the drawing, the above-described pair of registration rollers 34 is provided to send out a sheet P sandwiched between the pair of registration rollers 34 toward the secondary transfer nip synchronizing with the four-color toner image borne on the intermediate transfer belt 61. Thus, in the secondary transfer nip, the four-color toner image on the intermediate transfer belt 61 is transferred therefrom onto a sheet P under influence of the secondary transfer field and nip pressure to be a full-color image in contrast to a white color of the sheet P as a background.

Toner not transferred onto the sheet P in the secondary transfer nip remains and adheres to the surface of the intermediate transfer belt 61 passing the secondary transfer nip as transfer residual toner. However, the transfer residual toner is subsequently removed by a belt cleaner 75 contacting the intermediate transfer belt 61.

The sheet P passing through the secondary transfer nip separates from the intermediate transfer belt 61 and is passed to a conveyance belt unit 35. In the conveyance belt unit 35, the endless conveyor belt 36 is stretched by driving and driven rollers 37 and 38, and is endlessly moved as the driving roller 37 rotates counterclockwise in the drawing. Further, the sheet P passing from the secondary transfer nip is then conveyed and passed to the fixing device 40 as a fixing means being held on the conveyor belt 36 as the conveyor belt 36 endlessly moves.

In this printer, a re-feeding device is constructed by a conveyance direction switching device 50, a re-feeding path 54, a switchback path 55, and a post switchback conveyance path or the like. Specifically, the conveyance direction switching device 50 switches a conveyance destination between the sheet exiting path 51 and the re-feeding path 54 after receiving the sheet P from the fixing device 40. Accordingly, when a printing job is executed in a single-sided mode to form an image only on a first side of the sheet P, the sheet exiting path 51 is designated as the conveyance destination thereof. By doing so, the sheet P with the image only on its first side is conveyed toward a pair of sheet exiting rollers 52 via the sheet exiting path 51 and is discharged onto the sheet exiting tray 53. Further, when a printing job is executed in a duplex mode to form images on both respective sides of the sheet P and the sheet P with fixed images on its both sides is received from the fixing device 40 and the conveyance direction switching device 50 designates the sheet exiting path 51 as a conveyance destination. By doing so, the double-sided sheet P with the images thereon is discharged onto the sheet exiting tray 53. Whereas, when a printing job is executed in the duplex mode to form images on both of the respective sides of the sheet P, and the sheet P with a fixed image only on its one side is received from the fixing device 40, the conveyance direction switching device 50 designates the re-feeding path 54 as the conveyance destination.

Further, when the sheet P is reversed between front and back sides to form images on both sides of the sheet P in a duplex mode printing job, the following operation is performed. Specifically, the switchback path 55 is connected to the re-feeding path 54 so that the sheet P sent to the re-feeding path 54 can enter the switchback path 55. Thus, when the whole area of the sheet P in a conveyance direction enters the switchback path 55, a conveyance direction of the sheet P is reversed so that the sheet P can be switched back. A post switchback conveyance path 56 joins with the switchback path 55 in addition to the re-feeding path 54, and the sheet P switched-back in this way enters the post switchback conveyance path 56, so that the sheet P is reversed between front and back sides.

After the front and back sides are reversed, the sheet P is resent to the secondary transfer nip via the post switchback conveyance path 56 and the sheet feeding path 30 as well. Subsequently, the toner image is transferred onto the second side of the sheet P in the secondary transfer nip and is fixed thereafter onto the second side in the fixing device 40. The sheet P then exits from the apparatus onto the sheet exiting tray 53 via a series of the conveyance direction switching device 50, the sheet exiting path 51, and the pair of sheet exiting rollers 52.

Further, this printer has a full-color image formation mode to form a four-color image with Y, M, C, and K toner particles and a black and white image formation mode only to form a K-toner image, for example. The choice is arbitrarily set by an operator through an operation unit of the printer or a print screen of a personal computer, not shown.

When the full-color image mode is selected, toner images are formed on the respective photoconductors 3Y, 3M, 3C, and 3K in the four process units 2Y, 2M, 2C, and 2K corresponding to respective image information pieces, and are transferred onto the intermediate transfer belt 61 one by one, and are further transferred onto the sheet P at once in the secondary transfer nip. Subsequently, the fixing device 40 executes a process of melting and fixing of the full-color toner image. In the monochrome image formation mode only using K-color image data only activates the image formation process unit 2K for a K-color toner image. After transferring of the K-toner image from the photoconductor 3K onto the intermediate transfer belt 61, a final image is obtained on the sheet P in the same process as executed in the full-color image formation mode.

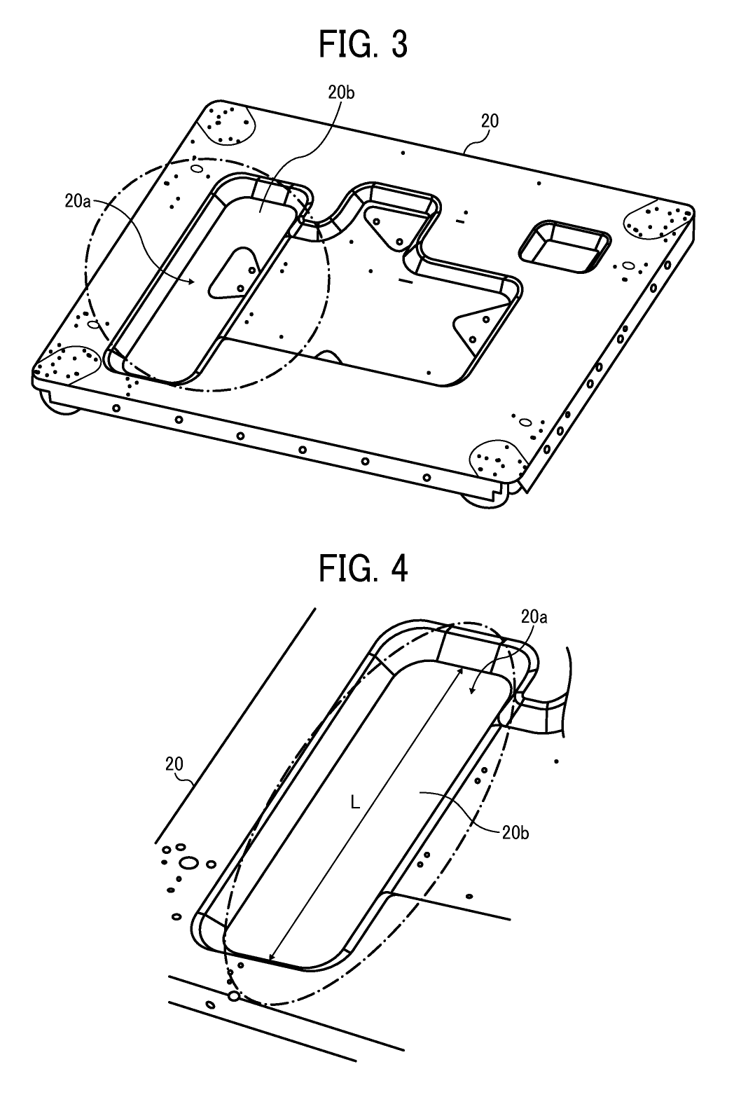

Now, a first exemplary configuration of the base structure 20 is described with reference to applicable drawing. FIG. 3 is a perspective view illustrating the base structure 20 according to the first exemplary configuration. The base structure 20 of this exemplary configuration is prepared by applying a deep drawing process to a metal plate having a given thickness, and is formed in a box shape having an opening on its one side when installed at a lower side of the image forming apparatus. Such a base structure 20 can be made of resin and is molded into a box shape by an injection molding method using a die.

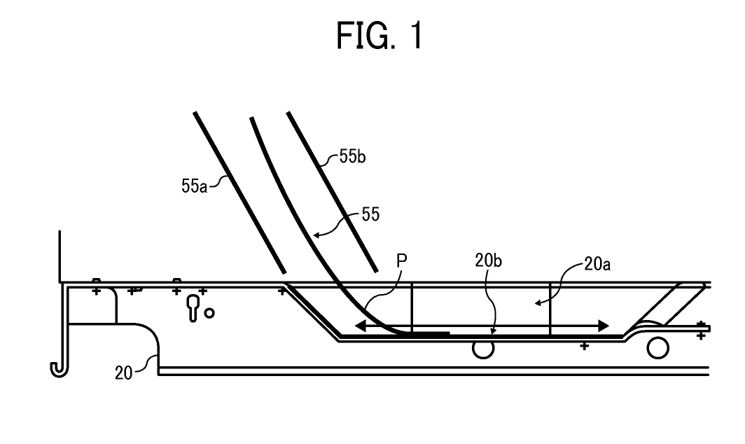

As shown back in FIG. 1, a bottom face of the recessed portion 20a formed in the base structure 20 by applying the deep drawing process is used as a guiding surface 20b to guide the sheet P when the sheet P is reversed. Further, as shown in FIG. 4, a width L of the guiding surface 20b of the recessed portion 20a is greater than the maximum width available to the image forming apparatus in feeding a sheet P. Further, to eliminate scratches and burrs thereby inhibiting jamming or cut on it due to wrecking when the sheet P is sent to the guide surface 20b, a surface treatment is applied to at least the guiding surface 20b among the whole area of the base structure 20 to have a smooth surface not to create a projection having a bar ring or emboss shape thereon.

Here, when the re-feeding path 54 serving as a sheet conveyance path for conveying the sheet P when it is to be reversed is connected to the switchback path 55 at a steep angle, sheet jamming or folding possibly occurs as a problem. Therefore, the re-feeding path 54 is desirably smoothly connected to the switchback path 55 at a moderate angle as in this embodiment. However, if the re-feeding path 54 is simply smoothly connected to the switchback path 55 at such a moderate angle, a length of the conveyance path of either the re-feeding path 54 or the switchback path 55 needs to be longer than that connected to each other at the steep angle. Consequently, a height of the image forming apparatus increases and the image forming apparatus likely becomes bulky.

By contrast, in this embodiment, when it is to be reversed the tip of the sheet P passing through the switchback path 55 constituted by the pair of guide plates 55a and 55b is led to the recessed portion 20a formed by applying the deep drawing process to the base structure 20 to contact the bottom face of the recessed portion 20a serving as the guiding surface 20b. Specifically, the sheet P is conveyed being guided by the guiding surface 20b in a widthwise direction (i.e., a lateral direction in the drawing and substantially horizontally) of the apparatus. Hence, a conveyance direction of the sheet P conveyed to the recessed portion 20a of the base structure 20 through the switchback path 55 extending in an apparatus height direction (i.e., substantially vertically) is bent by the guiding surface 20b to an apparatus widthwise direction therefrom. Therefore, by a length by which the tip of the sheet P is conveyed in the widthwise direction on the guiding surface 20b in the recessed portion 20a, the vertical length of the switchback path 55 can be further deceased thereby effectively downsizing the image formation apparatus.

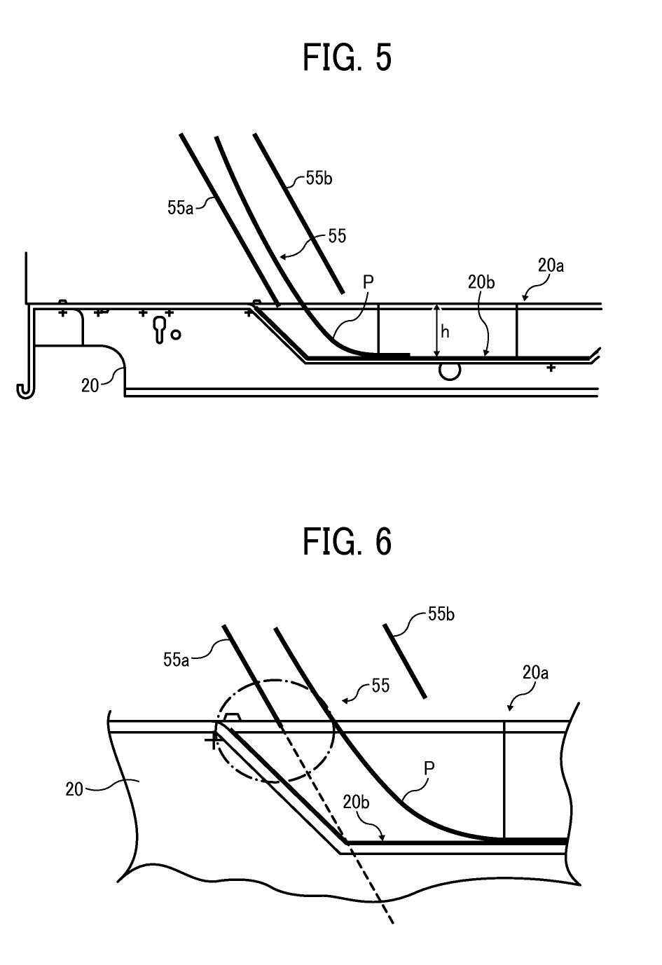

In particular, by using the bottom face of the recessed portion 20a formed by applying the deep drawing process to the base structure 20 as the guide surface 20b for the sheet P as in this embodiment, the length of the conveyance path of the switchback path 55 can be decreased substantially by an amount of a depth “h” of the recessed portion 20a as shown in FIG. 5. Accordingly, since the height is more decreased, the image forming apparatus can be made more compact.

Here, it is possible that the portion of the base structure 20 is not used as such a guiding surface for guiding the sheet P, and instead, either a pair of guide plates 55a and 55b can be extended or another guide plate separate from the pair of guide plates 55a and 55b can be disposed above the base structure 20 in a surface extending direction of the base structure 20 (i.e., the widthwise direction) to form the switchback path 55. However, in such a situation, either the pair of guide plates 55a and 55b forming the switchback path 55 becomes bulky or the apparatus becomes costlier due to the increase in number of components. By contrast, by utilizing the portion of the base structure 20 provided already in the image forming apparatus as the guiding surface 20b to guide the sheet P as in this embodiment, upsizing of the apparatus and an increase in the number of components can be minimized and costs reduced.

Further, as shown in FIG. 1, by locating the tip of the guide plate 55a of the switchback path 55 and a side of the recessed portion 20a to smoothly connect each other at a joint therebetween, the sheet P can be smoothly conveyed from the switchback path 55 to the recessed portion 20a. An angle formed by an intersection of the side and the bottom face of the recessed portion 20a is preferably about 30 degrees to about 45 degrees, and practically 45 degrees is used in this embodiment.

Further, to suppress buckling of the sheet P, the sheet P can be conveyed and only guided from the switchback path 55 to a flat bottom face of the recessed portion 20a. For example, as shown in FIG. 6, the guide plate 55a forming the switchback path 55 is disposed to almost overlap with the recessed portion 20a up to a position in which a virtual line passing through the tip of the guide plate 55a intersects with the bottom face of the recess 20a. Thus, the sheet P guided by the pair of guides 55a and 55b forming the switchback path 55 is thereby led only to the bottom face of the recessed portion 20a.

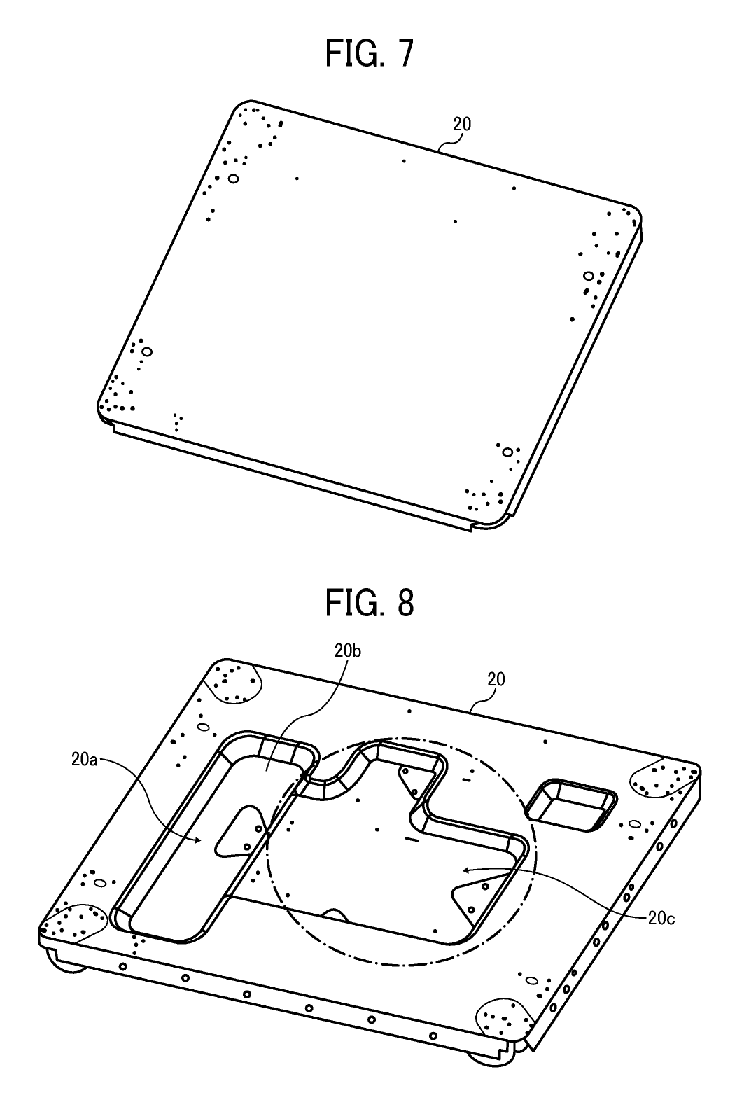

Here, torsional rigidity of the base structure 20 increases when the deep drawing process is applied to an upper surface of the box as shown in FIG. 3 compared to when the upper surface thereof is simply a plane surface as shown in FIG. 7. For this reason, in addition to the recessed portion 20a having the above-described guiding face 20b formed by applying the deep drawing process to a portion as illustrated by a circle in the FIG. 3, another recessed portion 20c is desirably formed at another portion of the box as illustrated by a circle in FIG. 8. In the other recess 20c formed by applying the deep drawing process to the other portion as illustrated by the circle in FIG. 8, a dehumidifying heater may be installed to dehumidify the sheet P contained in the first and second sheet feeding cassettes 101 and 102 located above the base structure 20 in the image formation apparatus, for example.

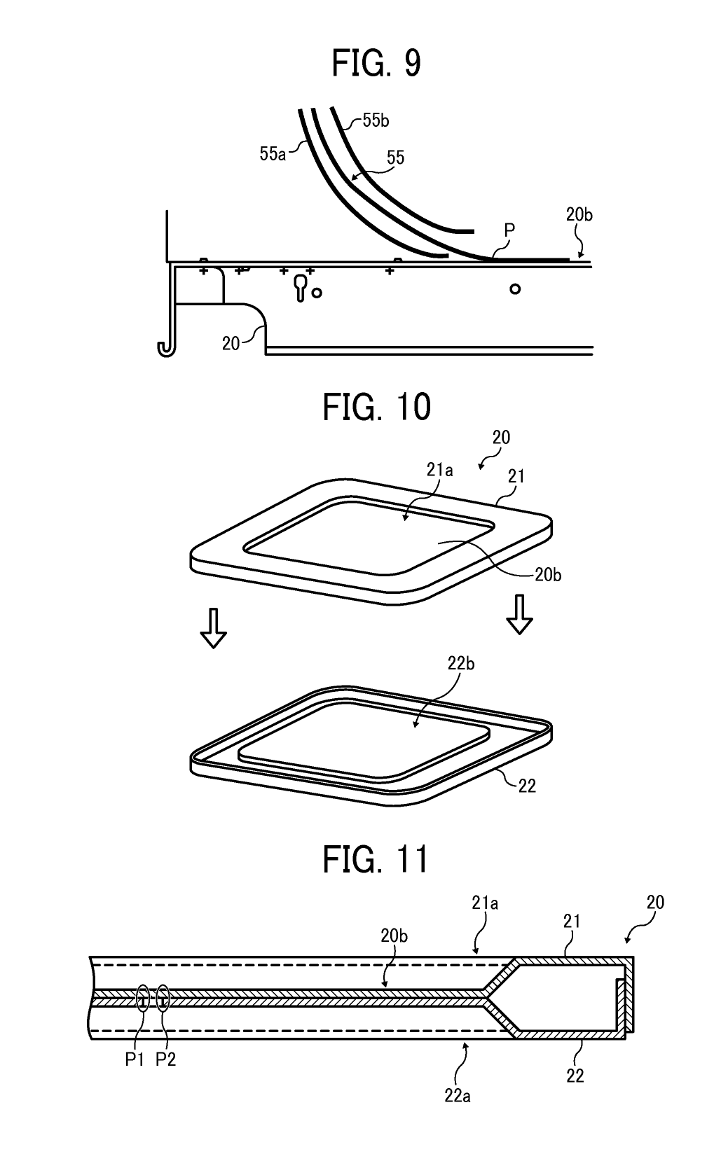

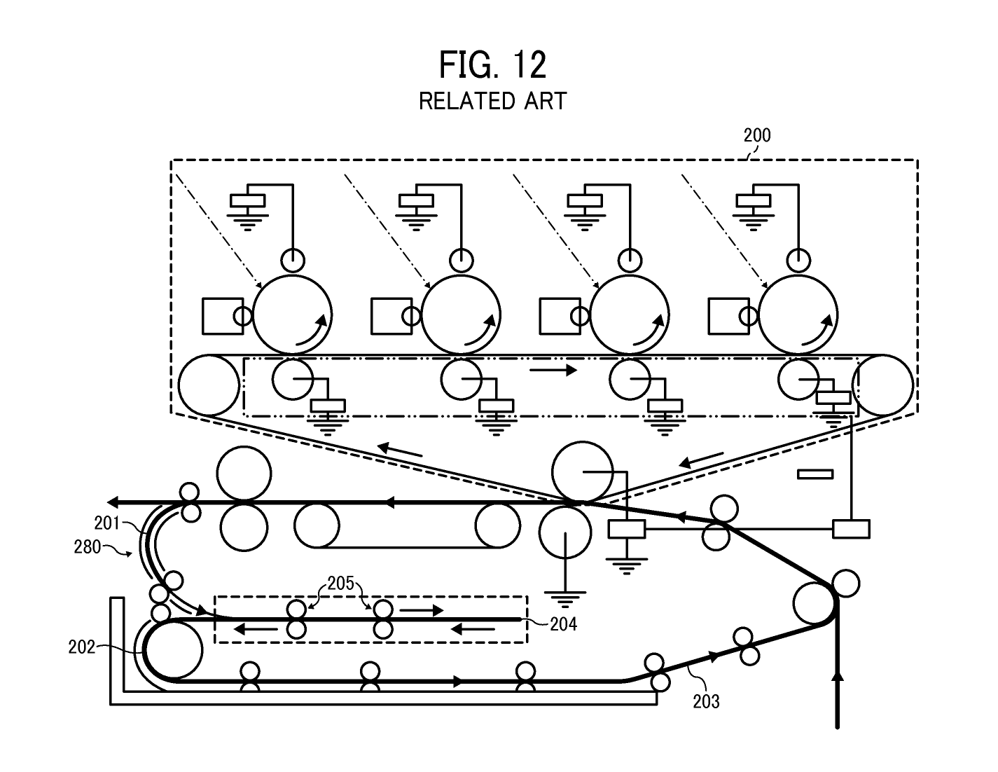

Further, the recessed portion 20a with the guiding surface 20b can be omitted by applying the deep drawing process to the upper surface of the base structure 20. In such a situation, a portion of the upper surface of the base structure 20 used as the guiding surface 20b is preferably smooth excluding convex portions or the like, and the sheet P is preferably conveyed from the switchback path 55 to the guiding surface 20b of the base structure 20 at a prescribed angle capable of preventing the sheet P from buckling when engaging the above-described guiding surface 20b as shown in FIG. 9.

A second exemplary configuration is now described with reference to applicable drawing. The base structure 20 can be prepared by applying the deep drawing process to metal plates, connecting opening sides of the upper and lower metal plates with each other, and assembling and welding those in a lunch box-shape as shown in FIG. 10. Hence, even the base structure 20 partially has a hollow structure internally, it can be sufficiently rigid.

Specifically, FIG. 10 is an exploded perspective view illustrating the base structure 20 of the second exemplary configuration, and the base structure 20 is dissolved into upper and lower metal plates 21 and 22 as shown there. From this state, the upper and lower metal plates 21 and 22 are assembled to form the lunch box shape and is connected to each other by welding. Here, the lunch box shape represents an aspect when one of two boxes fits into the other one of two boxes (i.e., coupled) with these openings formed on respective sides engaging each other in this embodiment.

The upper and lower metal plates 21 and 22 are each prepared by applying a deep drawing process to a thick-walled metal plate having a prescribed thickness. From such a sheet of the metal plate, a box with an opening on its one side is prepared including a concaved portion 21a or a convex portion 22a as shown in FIG. 10. That is, when the upper and lower side surfaces of the respective upper and lower metal plates 21 and 22 are simply flat, rigidity of those become relatively low so that strength of the base structure 20 decreases as a result. Therefore, in this exemplary configuration, the concaved portion 21a and the convex portion 22a symmetrically disposed to engage each other when the upper and lower of metal plates 21 and 22 are coupled to increase the rigidity of those enhancing the strength of the base structure 20 as a whole.

Subsequently, when these opening sides of the respective upper and lower metal plates 21 and 22 of the base structure 20 are engaged fitting into the other in the lunch box shape, the respective upper and lower of metal plates 21 and 22 can be firmly fixed by using at least one of plug welding and spot welding methods as described later with reference to FIG. 11. Therefore, without using a large welding device, the base structure 20 can be readily manufactured at low-cost.

In the thus-manufactured base structure 20, by using a bottom face of the concaved portion 21a of the upper metal plate 21 as the guiding surface 20b to guide the sheet P conveyed into the base structure 20 from the switchback path 55 when the sheet P is reversed, the image forming apparatus can be downsized due to the above-described reasons.

FIG. 11 is a cross-sectional view illustrating an essential part of the base structure 20 configured in the lunch box-shape by combining the upper and lower metal plates 21 and 22.

As shown there, an underside of the concaved portion 21a of the upper metal plate 21 and an upper side of the convex portion 22a of the lower metal plate 22 are engaged making surface contact. Subsequently, multiple welding points P1 and P2, in which edges of each of penetration holes formed on the upper side of the convex portion 22a of the lower metal plate 22 and the underside of the concaved portion 21a of the upper metal plate 21 contact each other, are connected by spot welding.

However, when the base structure 20 is assembled by fitting the upper metal plate 21 with the concaved portion 21a into the lower metal plate 22 with the convex portion 22a and power is applied to the upper metal plate 21 or the lower metal plate 22, a positional relation between the upper side of the convex portion 22a and the lower side of the concaved portion 21a likely changes. Then, to suppress such displacement between the upper side of the convex portion 22a and the lower side of the concaved portion 21a of the upper metal plate 21 and the lower metal plate 22, the lower side of the concaved portion 21a and the upper side of the convex portion 22a are welded to firmly join each other as described above. A portion other than the guiding surface 20b of the bottom face of the concaved portion 21a of the upper metal plate 21 is used as the welding point to weld the lower side of the concaved portion 21a and the upper side of the convex portion 22a together. Hence, the sheet P is rarely caught by the welding pint.

The above-described embodiments are just typical examples having the below described advantages. According to one embodiment of the present invention, enlargement of an apparatus can be effectively minimized while reducing defective sheet conveyance during a sheet reversing process. Specifically, according to one embodiment of the present invention, defective conveyance possibly arising when a sheet is reversed can be minimized while avoiding enlargement of the system. Because, an image forming apparatus comprises an image formation unit to form an image on a sheet, a reversing path extended vertically to receive and reverse front and rear sides of the sheet by changing a conveyance direction of the sheet to an opposite direction, a curved importing path to send the sheet with the image formed by the image formation unit into the reversing path, an exporting path to receive the sheet sent from the reversing path, a sheet re-feeding path to re-feed the sheet on the exporting path to the image formation unit, and a base structure to support a main body of the image forming apparatus at a bottom thereof. Such a base structure includes a guiding surface to guide the sheet sent from the importing path to the reversing path and change a sheet conveyance direction substantially from a vertical direction to a horizontal direction.

According to another embodiment of the present invention, the rigidity of the base structure can be enhanced, because, the base structure is made of metal and the recessed portion is prepared by applying a deep drawing process to the base structure. According to yet another embodiment of the present invention, a sheet can be smoothly delivered from the sheet reversing path to the recessed portion, because the reversing path includes a plate as a reversing path forming member, and the plate and the recessed portion are relatively positioned to provide a smooth joint therebetween. According to yet another embodiment of the present invention, sheet buckling can be minimized, because the reversing path forming member overlaps with the recessed portion until a position at which a virtual line extended through the end of the reversing path forming member and the bottom face of the recessed portion intersect each other.

Numerous additional modifications and variations of the present invention are possible in light of the above teachings. It is therefore to be understood that within the scope of the appended claims, the present invention may be executed otherwise than as specifically described herein.

What is claimed is:

1. An image forming apparatus comprising:
an image formation unit to form an image on a sheet;
a reversing path extended vertically to receive and reverse front and rear sides of the sheet by changing a conveyance direction of the sheet to an opposite direction;
a curved importing path to send the sheet with the image formed by the image formation unit into the reversing path;
an exporting path to receive the sheet sent from the reversing path;
a sheet re-feeding path to re-feed the sheet on the exporting path to the image formation unit; and
a base structure to support a main body of the image forming apparatus at a bottom thereof, the base structure including a guiding surface to guide and change a conveyance direction of a tip of the sheet sent from the importing path to the reversing path substantially from a vertical direction to a horizontal direction.

2. The image forming apparatus as claimed in claim 1, wherein the base structure is made of metal.

3. The image forming apparatus as claimed in claim 1, wherein the base structure includes a recessed portion having a bottom face on its upper surface, the bottom face constituting the guiding surface.

4. The image forming apparatus as claimed in claim 3, wherein the recessed portion is prepared by applying a deep drawing process to the base structure.

5. The image forming apparatus as claimed in claim 3, wherein the reversing path includes a plate as a reversing path forming member, wherein the plate of the reversing path forming member and the recessed portion are conjoined to provide a smooth joint therebetween.

6. The image forming apparatus as claimed in claim 3, wherein the reversing path includes a plate as an reversing path forming member, wherein the reversing path forming member overlaps with the recessed portion up to a position at which a virtual line of the reversing path forming member extending through its one end and the bottom face of the recessed portion intersect each other.

7. A sheet reversing system comprising:
a reversing path extended vertically to receive and reverse front and rear sides of a sheet by changing a conveyance direction of the sheet to an opposite direction;
a curved importing path to send the sheet with an image formed by an image formation unit into the reversing path;
an exporting path to receive the sheet sent from the reversing path;
a sheet re-feeding path to re-feed the sheet on the exporting path to the image formation unit; and
a base structure to support a main body of the image forming apparatus at a bottom thereof, the base structure including a guiding surface to guide and change a conveyance direction of a tip of the sheet sent from the importing path to the reversing path substantially from a vertical direction to a horizontal direction.

8. The sheet reversing system as claimed in claim 7, wherein the base structure is made of metal.

9. The sheet reversing system as claimed in claim 7, wherein the base structure includes a recessed portion having a bottom face on its upper surface, the bottom face constituting the guiding surface.

10. The sheet reversing system as claimed in claim 9, wherein the recessed portion is prepared by applying a deep drawing process to the base structure.

11. The sheet reversing system as claimed in claim 9, wherein the reversing path includes a plate as a reversing path forming member, wherein the plate of the reversing path forming member and the recessed portion are conjoined to provide a smooth joint therebetween.

12. The sheet reversing system as claimed in claim 9, wherein the reversing path includes a plate as an reversing path forming member, wherein the reversing path forming member overlaps with the recessed portion up to a position at which a virtual line of the reversing path forming member extending through its one end and the bottom face of the recessed portion intersect each other.

13. A method for forming a duplex image comprising the steps of:
forming an image on a sheet;
receiving and reversing front and rear sides of the sheet by changing a conveyance direction of the sheet to an opposite direction in a reversing path;
sending the sheet with the image formed by the image formation unit into the reversing path;
receiving the sheet sent from the reversing path;
re-feeding the sheet on the exporting path to the image formation unit; and
guiding and changing a conveyance direction of a tip of the sheet sent from the importing path to the reversing path substantially from a vertical direction to a horizontal direction at a bottom of the image forming apparatus using a base structure.

14. The method as claimed in claim 13, wherein the base structure is made of metal.

15. The method as claimed in claim 13, wherein the base structure includes a recessed portion having a bottom face on its upper surface, the bottom face constituting the guiding surface.

16. The method as claimed in claim 15, wherein the recessed portion is prepared by applying a deep drawing process to the base structure.

17. The method as claimed in claim 15, wherein the reversing path includes a plate as a reversing path forming member, wherein the plate of the reversing path forming member and the recessed portion are conjoined to provide a smooth joint therebetween.

18. The method as claimed in claim 15, wherein the reversing path includes a plate as an reversing path forming member, wherein the reversing path forming member overlaps with the recessed portion up to a position at which a virtual line of the reversing path forming member extending through its one end and the bottom face of the recessed portion intersect each other.
